(19) United States
(12) Patent Application Publication
(10) Pub. No.: US 2025/0370667 A1
(43) Pub. Date: Dec. 4, 2025

(54) NON-TRANSITORY COMPUTER-READABLE STORAGE MEDIUM STORING INSTRUCTIONS IMPLEMENTING SUPPORTING PROGRAM

(71) Applicant: BROTHER KOGYO KABUSHIKI KAISHA, Nagoya (JP)

(72) Inventors: Yushi ICHIKAWA, Nagoya (JP); Kenju NARITA, Nagoya (JP); Yoshito HOSOMIZO, Konan (JP); Airi EGUCHI, Ichinomiya (JP)

(21) Appl. No.: 19/304,820

(22) Filed: Aug. 20, 2025

Related U.S. Application Data
(63) Continuation of application No. PCT/JP2024/005601, filed on Feb. 16, 2024.

(30) Foreign Application Priority Data
Feb. 21, 2023 (JP) 2023-025147

(51) Int. Cl. G06F 3/12; G06Q 30/0601

(52) U.S. Cl. CPC G06F 3/121; G06F 3/1204; G06F 3/1225; G06F 3/1255; G06Q 30/06313

(57) ABSTRACT

A supporting program for a printer, when executed by a controller of an information processing device, causes the information processing device connectable to the printer, to perform printing processing in response to a universal printing program receiving, from the application program, a print instruction that causes the printer to print an image to be printed, and to receive an error event from the universal printing program, the error event being output by the universal printing program in response to the universal printing program receiving an error notification from the printer after the printing. In a case where the error event output from the universal printing program indicates an insufficient consumable error, the supporting program causes the information processing device to perform notification processing of displaying a notification screen that prompts purchase of a replacement consumable on a user interface of the information processing device.

### REFERENCE TO RELATED APPLICATIONS

This is a continuation application of International Application No. PCT/JP2024/005601 filed on Feb. 16, 2024, which claims priority from Japanese Patent Application No. 2023-025147 filed on Feb. 21, 2023. The entire contents of the aforementioned applications are incorporated herein by reference.

### BACKGROUND ART

Some known techniques have been developed for monitoring remaining amounts of consumables in printers. For example, one technique involves a system including a printer, a personal computer (PC), and a consumables supplier database site. In such a system, in response to a print instruction, the printer or the PC determines whether an ink remaining amount is equal to or less than a threshold based on ink remaining amount information regarding an ink cartridge. If it is determined that the ink remaining amount is equal to or less than the threshold, the printer or the PC displays an order screen provided by the consumables supplier database site.

### SUMMARY

Another technique may involve controlling a printer using an OS-standard universal printing program that is part of an operating system (OS), without a printer driver provided by a printer vendor. More specifically, for example, in response to detecting a printer, the OS may establish association between the printer and the OS-standard universal printing program. Thereafter, in response to the OS receiving a print instruction for the printer, the OS-standard universal printing program may generate print data without a printer driver provided by a printer vendor, thereby enabling printing through the OS-standard universal printing program.

However, the OS-standard universal printing program might not have a function of displaying a purchase screen for consumables in response to a print instruction. That is, the OS-standard universal printing program might not have a function of providing guidance on the purchase of consumables. The absence of such functions may cause inconvenience to printer users when determining when to purchase consumables.

According to an aspect of the disclosure, a non-transitory computer-readable storage medium for an information processing device is provided, which includes a controller and stores computer-executable instructions that are executable by the controller. The computer-executable instructions implement a supporting program for a printer connectable to the information processing device. The information processing device has an operating system including a universal printing program. The information processing device is incorporated with an application program. The supporting program, when executed by the controller, causes the information processing device to perform, in response to the universal printing program receiving, from the application program, a print instruction that causes the printer to print an image to be printed, printing processing of causing the printer to print the image to be printed; receiving processing of receiving an error event from the universal printing program, the error event being output by the universal printing program in response to the universal printing program receiving an error notification from the printer after the printing; and in a case where the error event output from the universal printing program indicates an insufficient consumable error, notification processing of displaying a notification screen that prompts purchase of a replacement consumable on a user interface of the information processing device.

As described above in detail, in a case where the error event output by the universal printing program in response to a print instruction indicates an insufficient consumable error, the supporting program may display the notification screen that prompts purchase a replacement consumable on the information processing device. Such a configuration may enable a user to recognize the need to purchase a replacement consumable, thereby increasing the likelihood that the user will purchase the replacement consumable.

Apparatuses and control methods for implementing the functions of the supporting program may also have novelty and utility.

According to aspects of the disclosure, a technique for clearly indicating the timing for purchasing printer consumables may be implemented in an information processing device in which an OS-standard universal printing program is installed.

### BRIEF DESCRIPTION OF THE DRAWINGS

FIG. 1 is a block diagram schematically illustrating an electrical configuration of a personal computer.

FIG. 2A is a sequence diagram illustrating an example of a print execution procedure.

FIG. 2B is a continuation of FIG. 2A.

FIG. 3 is a flowchart illustrating an example of an update process.

FIG. 4 is a flowchart illustrating an example of a screen display process.

FIG. 5 illustrates an example of screen transitions, including a notification screen.

FIG. 6 is a flowchart illustrating an example of a restriction setting process.

FIG. 7 is a flowchart illustrating another example of a screen display process.

FIGS. 8A, 8B, and 8C illustrate other examples of the notification screen.

### DESCRIPTION

Hereinafter, a personal computer (“PC”) using a supporting program of an illustrative embodiment will be described in detail with reference to the accompanying drawings. The disclosure discloses the supporting program executed by the PC.

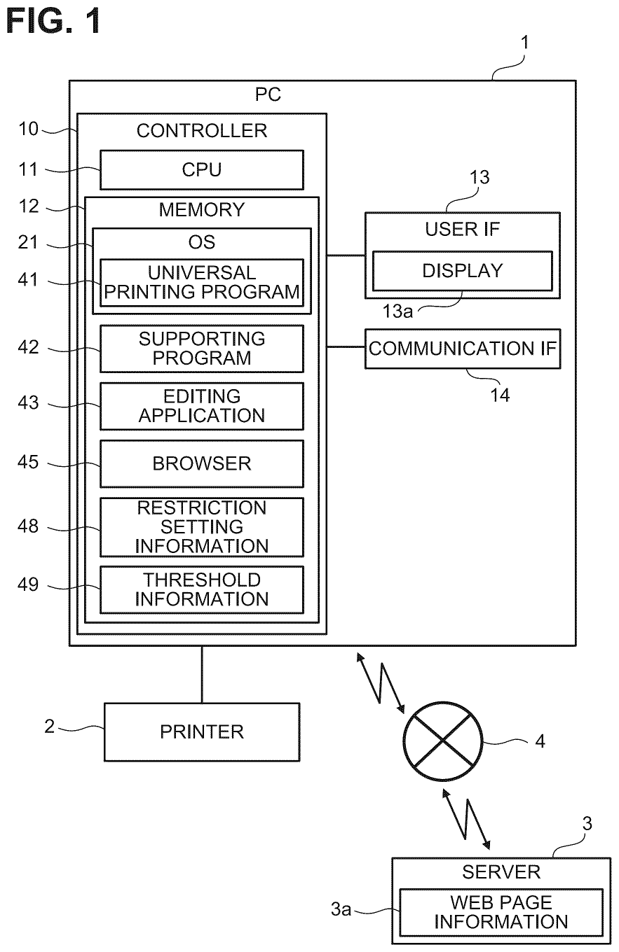

As illustrated in FIG. 1, a PC 1 of the illustrative embodiment includes a controller 10 including a CPU 11 and a memory 12. The PC 1 is an example of an information processing device. The CPU 11 is an example of a computer. The PC 1 includes a user interface (“user IF”) 13 and a communication interface (“communication IF”) 14, which are electrically connected to the controller 10. The term “controller 10” used in FIG. 1 may be a collective term for hardware and software used to control the PC 1, and might not necessarily represent a single piece of hardware actually existing in the PC 1.

The CPU 11 of the PC 1 executes various types of processing in accordance with a program read from the memory 12 or based on user input. The memory 12 stores various programs and data. The memory 12 also serves as a workspace for processing. A buffer of the CPU 11 is an example of the memory 12. Examples of the memory 12 further include storage media readable and writable by the CPU 11, for example, recording media such as CD-ROMs and DVD-ROMs, as well as a ROM, a RAM, a hard disk drive built in the PC 1.

The user IF 13 includes a display 13a, which is hardware for displaying information to a user. Further, the user IF 13 includes hardware for user input. In one example, the user IF 13 may be a combination of the display 13a and an input device, such as a mouse and/or a keyboard. In another example, the user IF 13 may be a touch screen having both display and input functions.

The communication IF 14 includes hardware that enables the PC 1 to communicate with an external device such as the printer 2 and a server 3. Examples of a communication standard for the communication IF 14 include Ethernet, Wi-Fi, and USB. Wi-Fi is a registered trademark of Wi-Fi Alliance. The PC 1 may be connectable to the Internet via the communication IF 14. The PC 1 may include multiple communication IFs 14 for supporting multiple communication standards.

As illustrated in FIG. 1, the memory 12 of the PC 1 stores various programs and data. The program may include, for example, an operating system (“OS”) 21, a supporting program 42, an editing application 43, and a browser 45. The OS 21 includes a universal printing program 41. The data may include, for example, restriction setting information 48 and threshold information 49. The supporting program 42 is an example of a supporting program. The editing application 43 is an example of an application program.

The OS 21 may be a multitasking OS that manages multiple tasks and switches between the multiple tasks, thereby handling several tasks simultaneously. The OS 21 may be, for example, Windows, macOS, Linux, iOS, or Android. Windows is a trademark of the Microsoft group of companies. macOS is a trademark of Apple Inc., registered in the U.S. and other countries and regions. Linux is the registered trademark of Linus Torvalds in the U.S. and other countries. IOS is a trademark or registered trademark of Cisco Systems, Inc. in the U.S. and other countries and is used under license. Android is a registered trademark of Google LLC.

The OS 21 includes the universal printing program 41. The universal printing program 41 is an OS-standard program that is developed by a vendor of the OS 21 and provided as part of the OS 21. The universal printing program 41 is designed to allow for the absence of printer-specific drivers.

The universal printing program 41 enables various types and models of printers provided by different vendors to perform printing based on user instructions. The universal printing program 41 supports general functions that enable various printers to perform printing. Unlike printer-specific drivers, the universal printing program 41 does not support a specific function that a printer or printer driver has, in particular, a function requiring complicated processing.

The universal printing program 41 includes a function of generating intermediate image data based on image data received as data to be printed that has been specified in a print instruction received from an application, based on a user instruction. The intermediate image data may be, for example, data in XPS format. “XPS” is an abbreviation for XML Paper Specification. The universal printing program 41 further has a function of generating print data in a format available for printing by various types of printers based on the intermediate image data. The print data may be, for example, PWG Raster data or PDF data. The universal printing program 41 further has a function of transmitting the generated print data to a printer designated as a device for printing, using a communication function of the OS 21.

The supporting program 42 consists of a single program or a group of programs that execute processing based on an instruction received from the OS 21 in association with the processing executed by the universal printing program 41, and that support control of target hardware. The supporting program 42 is provided for the model of the printer 2 connected to the PC 1, for example, by the vendor of the printer 2. The universal printing program 41 activates the supporting program 42 for the printer 2 based on a specific condition. The specific condition may be, for example, the designation of the printer 2 as a device for printing, the reception of an instruction to specify advanced print settings while the printer 2 is designated, or the reception of an instruction to cause the printer 2 to perform printing. The supporting program 42 may be, for example, a Print Support Application (“PSA”) or a Hardware Support Application (“HSA”).

In one example, the supporting program 42 may be a combination of a plurality of programs that receive execution commands, respectively. In another example, the supporting program 42 may be a single program configured to execute different types of processing based on received commands. Supporting programs may be prepared for different types of printers by a printer vendor. For example, one supporting program may be for inkjet printers and another supporting program may be for laser printers. Supporting programs may be prepared not only for types of printers but also for different models of printer or different series of printer models.

For example, when a particular printer is connected to the PC 1 for the first time, the OS 21 of the PC 1 may download a supporting program appropriate for the type or model of the printer from a server of the vendor of the printer, and install the supporting program on the PC 1. The OS 21 stores identification data of the installed supporting program into the memory 12 in association with printer data of the newly connected printer.

The editing application 43 may be, for example, a program for creating and editing image data and/or document data. The editing application 43 may be, for example, Microsoft Word or Microsoft PowerPoint developed by Microsoft or may be a program provided by the vendor of the printer 2. Microsoft, Microsoft PowerPoint, and Microsoft Word are trademarks of the Microsoft group of companies. The editing application 43 may receive, via the user IF 13, for example, a print execution instruction to cause the printer 2 to perform printing. The editing application 43 is not limited to programs for creating and editing data, and may also include programs that have a function of receiving instructions to display or print various types of information, such as map information or web pages, in response to a user's request.

The browser 45 is a program for displaying web pages on the display 13a of the user IF 13. The PC 1 of the illustrative embodiment is connected to the server 3 via the Internet 4. The server 3 has at least a communication function. The server 3 has a function of managing the purchase of consumables. The server 3 has a web server function, and stores web page information 3a for displaying a purchase screen for consumables on an external device such as the PC 1.

The supporting program 42 can subscribe to an error event from the universal printing program 41. Once the subscription is established, the universal printing program 41 outputs an error event to the supporting program 42 in response to receiving an error notification from the printer 2. The supporting program 42 has a function of displaying a notification screen that prompts the purchase of a replacement consumable when the error event received from the universal printing program 41 indicates an insufficient consumable error. The supporting program 42 allows the user to enable or disable a restriction setting. Enabling the restriction setting may reduce inconvenience to the user caused by repeated displays of the same notification screen until the target consumable is replaced. In response to the insufficient consumable error being resolved, the supporting program 42 can automatically disable the restriction setting. This thus enables the supporting program 42 to display the notification screen when another insufficient consumable error occurs. Details of the functions of the supporting program 42 will be described later.

The restriction setting information 48 is stored in a nonvolatile area of the memory 12, and includes a flag indicating whether to display a notification screen. For example, in the restriction setting information 48, the flag is turned ON when the supporting program 42 receives a specification to enable the restriction setting, and the flag is turned OFF when the supporting program 42 receives a specification to disable the restriction setting.

The threshold information 49 is stored in the nonvolatile area of the memory 12. For example, the printer 2 may transmit an error notification regarding an insufficient consumable error to the universal printing program 41. In response to receiving the error notification, the universal printing program 41 may output an error event indicating an insufficient consumable error. The insufficient consumable error includes multiple consumable levels, such as an empty level, a near empty level, and a low level. The empty level may indicate that no consumable remains. The near empty level may indicate that the consumable is almost depleted. The low level may indicate that the consumable is running low and is expected to soon reach the near empty level. The timing of displaying the notification screen may be determined based on a level threshold. For example, the notification screen may be displayed when a consumable has reached the low level. However, some users might not intend to perform consumable replacement even when the currently-used consumable has reached the low level. Therefore, a remaining amount threshold that is used to determine the display timing of the notification screen may be preferably provided separately from the level threshold. Thus, the threshold information 49 includes such a remaining amount threshold for each consumable. The remaining amount threshold may be a fixed value or a variable value that can be specified by the user.

As illustrated in FIG. 1, the PC 1 of the illustrative embodiment is connected to the printer 2 via the communication IF 14. The printer 2 has at least a printing function and a communication function. For example, in response to receiving print data from the PC 1, the printer 2 may perform printing based on the received print data. The printer 2 of the illustrative embodiment is a color printer. In other embodiments, for example, the printer 2 may be a monochrome printer.

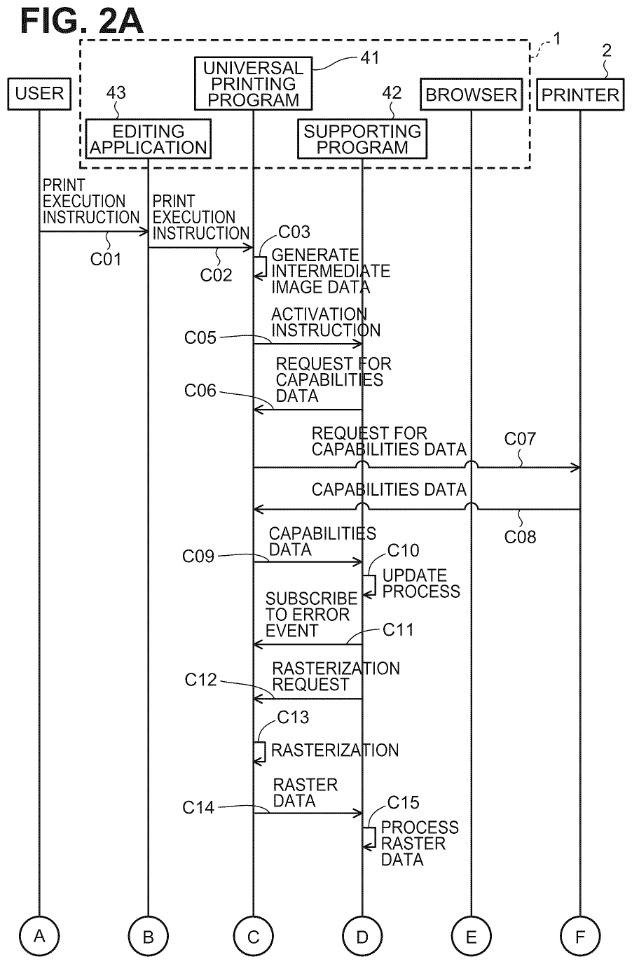

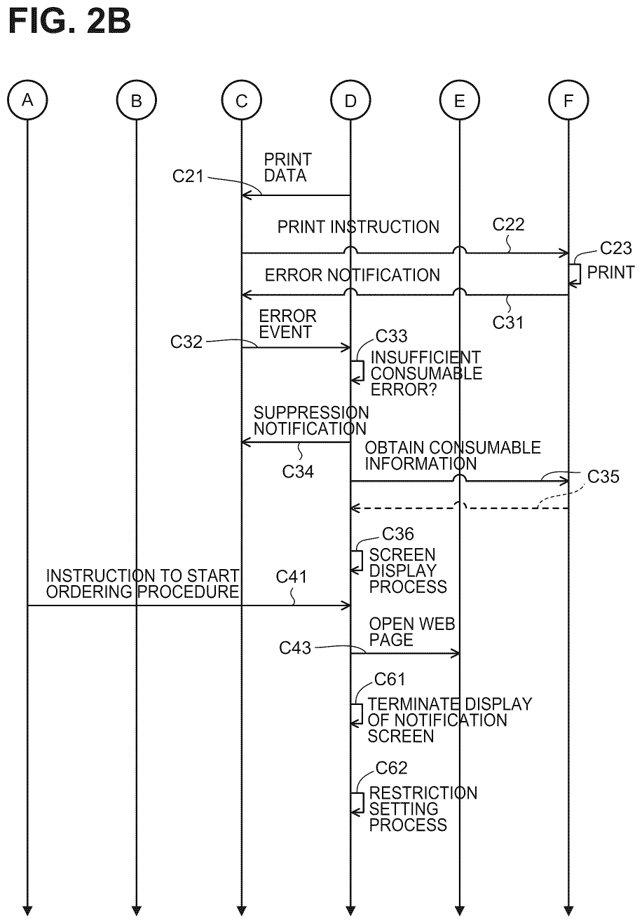

Next, a print execution procedure for causing the printer 2 to perform printing will be described with reference to FIGS. 2A and 2B. Here, as an example, the print execution procedure will be described in a case where the PC 1 designates the printer 2, which is a color printer, to perform printing.

Processing executed in each step in the illustrative embodiment essentially indicates processing executed by the CPU 11 in accordance with instructions written in a specific program, such as the supporting program 42. Processing executed by the CPU 11 also includes control of hardware using APIs of the OS 21. In the disclosure, a description will be provided on operations of the programs. A detailed description of the OS 21 will be omitted. The terms referring to coming into possession are used as a concept that does not require necessarily a request to obtain that possession.

After finalizing the image to be printed and the print settings for the printer 2, the user provides a print execution instruction via the editing application 43 (C01). The editing application 43 can display an editing screen and a print settings screen. The editing application 43 receives instructions from the user to create or edit a document or image via the editing screen. In response to receiving a selection of a printing function on the editing screen, the editing application 43 displays the print settings screen. The editing application 43 allows the user to designate a printer to be used for printing or specify various parameters on the print settings screen. More specifically, for example, based on the user's selection of a “Print” button on the print settings screen, the editing application 43 determines that a print execution instruction for the universal printing program 41 has been received. The print execution instruction instructs the printer 2 to print the specified image.

The editing application 43 passes the details of the print execution instruction to the universal printing program 41 (C02). The universal printing program 41 thus obtains image data representing the image to be printed and the print settings, as the details of the print execution instruction, from the editing application 43.

The universal printing program 41 generates intermediate image data by converting the image data to an intermediate image data format based on the print settings received from the editing application 43 (C03). The image data included in the editing application 43 is of various types. The universal printing program 41 thus converts the received image data to intermediate image data suitable for generating print data. Nevertheless, in other embodiments, for example, when the received image data is in a suitable format, the generation of intermediate image data may be omitted, and the image data may be used as intermediate image data without any conversion.

Prior to generating the intermediate image data, the universal printing program 41 may activate the supporting program 42 for the designated device, which may be the printer 2, and notify that processing for a print job has been started. In a case where the supporting program 42 is activated by the universal printing program 41, the supporting program 42 is allowed to pass various instructions to be used in the generation of intermediate image data, to the universal printing program 41 as necessary.

After generating the intermediate image data, the universal printing program 41 activates the supporting program 42 (C05). The supporting program 42 may obtain the intermediate image data generated by the universal printing program 41 by requesting the intermediate image data from the universal printing program 41. Then, the supporting program 42 may modify the intermediate image data received from the universal printing program 41 or print settings information, based on the print settings received via the print settings screen.

The supporting program 42 activated by the universal printing program 41 obtains the capabilities data from the printer 2 via the universal printing program 41 (C06, C07, C08, and C09). In this case, in steps C07 and C08, the universal printing program 41 communicates with the printer 2 via the OS 21 in compliance with, for example, the Internet Printing Protocol (“IPP”). In other embodiments, for example, the supporting program 42 may obtain the capabilities data from the printer 2 specified via the print settings screen, using, for example, the Management Information Base (“MIB”).

The capabilities data obtained from the printer 2 includes, for example, consumable remaining amount information. Examples of the consumable include a sheet, an ink cartridge or ink, a toner cartridge or toner, and a bulk package of sheets, such a package containing 100 sheets. In one example, when the printer 2 is an inkjet printer, the consumable remaining amount information includes a remaining amount of ink in an ink cartridge. In another example, when the printer 2 is an electrophotographic printer, the consumable remaining amount information includes a remaining amount of toner in a toner cartridge. When the printer 2 is a color printer, the capabilities data may include the consumable remaining amount information for each color. The capabilities data may include device information about the printer 2, such as a printer name and a printer model. The capabilities data may include information related to parameters that can be specified as print settings for the printer 2, or information related to available trays. Steps C06 to C09 are an example of “pre-obtaining processing”.

Subsequent to step C09, the supporting program 42 executes an update process in which the flag included in the restriction setting information 48 is updated (C10). The timing at which capabilities data is obtained and the timing at which the update process is executed may be different from the timings in the illustrative embodiment, as long as these timings are after a print instruction has been provided and before print data is output in step C21, that is, before a printing process is started. In a case where the supporting program 42 is activated before the intermediate image data is generated, in one example, the supporting program 42 may obtain the capabilities data and execute the update process before obtaining the intermediate image data. In another example, the supporting program 42 may obtain the capabilities data before obtaining the intermediate image data, and execute the update process after obtaining the intermediate image data. In still another example, the supporting program 42 may obtain the capabilities data and execute the update process after obtaining raster data.

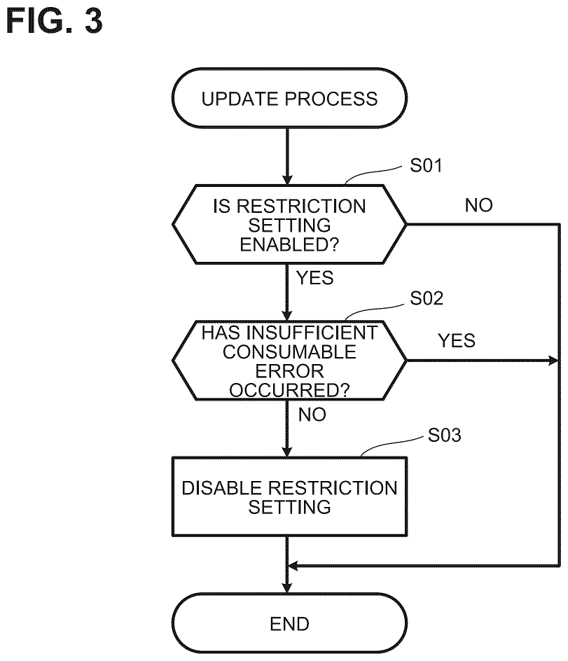

The update process will be described with reference to FIG. 3. The CPU 11 of the PC 1 determines whether the restriction setting is enabled (S01). If the flag in the restriction setting information 48 is ON, the CPU 11 determines that the restriction setting is enabled (S01: YES). In this case, the CPU 11 retrieves the consumable remaining amount information from the capabilities data, and determines, based on the retrieved information, whether an insufficient consumable error has occurred (S02). Step S02 is an example of “pre-determining processing”.

For example, the CPU 11 determines whether a consumable remaining amount included in the capabilities data is equal to or greater than the remaining amount threshold included in the threshold information 49. This determination may be performed on each consumable. If the remaining amounts of all the consumables are equal to or greater than the remaining amount threshold, the CPU 11 determines that an insufficient consumable error has not occurred (S02: NO). In this case, the CPU 11 turns the flag in the restriction setting information 48 from ON to OFF to disable the restriction setting (S03). This is because the insufficient consumable error has likely been resolved by consumable replacement. Disabling the restriction setting thus enables the notification screen to be displayed when another insufficient consumable error occurs. After completion of step C03, the CPU 11 ends the update process. Step S03 is an example of “disabling processing”.

If at least one of the remaining amounts of the consumables is less than the remaining amount threshold, the CPU 11 determines that an insufficient consumable error has occurred (S02: YES). In this case, the CPU 11 maintains the flag in the restriction setting information 48 ON, that is, does not disable the restriction setting. Thus, the restriction on displaying the notification screen continues, thereby avoiding displaying the notification screen to the user who is already aware of the insufficient consumable error every time printing is performed.

If the flag in the restriction setting information 48 is OFF, the CPU 11 determines that the restriction setting is disabled (S01: NO). In this case, the CPU 11 ends the update process without executing steps S02 and S03. This situation occurs when all the consumables currently in use remain above the low level. Since the restriction setting is not enabled, there is no need to disable the restriction setting.

Referring back to FIG. 2A, the supporting program 42 subscribes to an error event from the universal printing program 41 (C11). An error event can be output from the universal printing program 41 when the universal printing program 41 receives an error notification from the printer 2 used for printing. The error notification indicates that an error has occurred. Subscribing to an error event from the universal printing program 41 enables the supporting program 42 to receive an error event from the universal printing program 41.

The timing for subscribing to an error event (refer to step C11) can be at any time after the supporting program 42 is activated in response to a print instruction (i.e., after the supporting program 42 receives an activation instruction in step C05) and before the supporting program 42 executes a printing process (i.e., before the supporting program 42 outputs print data in step C21). In the illustrative embodiment, the supporting program 42 subscribes to an error event from the universal printing program 41 each time a print instruction is provided. Nevertheless, if the universal printing program 41 can maintain the error event subscription, the supporting program 42 may omit step C11.

The supporting program 42 passes the intermediate image data, and requests the universal printing program 41 to rasterize the intermediate image data (C12). The universal printing program 41 thus rasterizes the intermediate image data to generate raster data (C13). The raster data may be bitmap data. The universal printing program 41 then passes the generated raster data to the supporting program 42 (C14). Thus, the supporting program 42 obtains the raster data.

In other embodiments, for example, the supporting program 42 may perform rasterization instead of the universal printing program 41. More specifically, the supporting program 42 rasterizes the intermediate image data included in the received print execution instruction to generate raster data. The supporting program 42 may provide greater flexibility in rasterization than the universal printing program 41, which is likely to result in raster data that is suitable for printing by the printer 2. However, rasterization by the universal printing program 41 may enable the supporting program 42 to execute less processing, and may reduce the program size of the supporting program 42.

Subsequent to C13, the supporting program 42 processes the raster data obtained in step C14 as necessary, and encodes the processed raster image into PDL data to generate print data (C15). Subsequent to step C15, the supporting program 42 passes the generated print data to the universal printing program 41 and instructs the universal printing program 41 to transmit the print data to the printer 2 (C21). Step C21 is an example of “printing processing”.

The print data to be passed from the supporting program 42 to the universal printing program 41 in step C21 of FIG. 2B may be any type as long as the print data is in a format that can be printed by the printer 2. The PDL data generated by the supporting program 42 may be in a format that can be printed by printers in addition to models of the printer 2.

In response to the instruction received from the supporting program 42, the universal printing program 41 transmits the print data to the printer 2 and instructs the printer 2 to perform printing (C22). In response to the print instruction, the printer 2 performs printing based on the received print data (C23). As a result, a printed matter based on the print instruction output from the editing application 43 is generated.

The printer 2 that performs printing notifies the universal printing program 41 of the printing result. More specifically, for example, if an error occurs during printing and the printing fails, the printer 2 provides an error notification indicating the occurrence of the error to the universal printing program 41 (C31). Each error notification includes an error code. Each error code uniquely identifies an error type. Examples of the error types include “Cover Open”, “Empty Consumable”, “Near Empty Consumable”, “Low Consumable”, “No Sheet”, “Sheet Jam”, “Full Output Tray”, and “Almost Full Output Tray”.

In response to receiving, from the printer 2, the error notification including a particular error code, the universal printing program 41 outputs an error event based on the error event subscription established in step C11 (C32). The universal printing program 41 outputs an error event unique to the particular error code included in the error notification received from the printer 2.

In response to receiving the error event output from the universal printing program 41 after the supporting program 42 outputs the print data (C32), the supporting program 42 analyzes the type of the error event to determine whether the error event indicates an insufficient consumable error (C33). Step C33 is an example of “determining processing”.

In the illustrative embodiment, whether an error event indicates an insufficient consumable error is determined based on the type of the error event. Nevertheless, in other embodiments, for example, such a determination may be implemented in a different way. For example, the universal printing program 41 may output an error event without specifying any error type, and the supporting program 42 may determine the error type by obtaining, from the universal printing program 41, the error code included in the error notification.

If the supporting program 42 determines that the error event output from the universal printing program 41 indicates an insufficient consumable error (C33: YES), the supporting program 42 passes a suppression notification (C34). The universal printing program 41 normally has a function of automatically displaying an error notification screen on the user IF 13 to notify the occurrence of an error in response to receiving an error notification from the printer 2. In response to receiving, from the universal printing program 41, an error event indicating an insufficient consumable error, the supporting program 42 passes a suppression notification to the universal printing program 41 to enable an error notification suppression setting in the universal printing program 41. The suppression notification may specify that error notifications are unnecessary. Step C34 is an example of “setting processing”.

When the error notification suppression setting is enabled, the universal printing program 41 does not display any error notification screen on the user IF 13 even when the universal printing program 41 receives, from the printer 2, an error notification including an error code indicating an insufficient consumable error. That is, the universal printing program 41 does not notify errors caused by insufficient consumables. Such a configuration may thus avoid duplicate error notifications from both the universal printing program 41 and the supporting program 42.

The printer 2 transmits an error notification to the universal printing program 41 also when an error other than an insufficient consumable error occurs. The error other than the insufficient consumable error may be, for example, “Cover Open”, “Sheet Jam”, “Full Output Tray”, or “Almost Full Output Tray”. In those cases, the universal printing program 41 outputs an error event indicating an error other than the insufficient consumable error in step C32. Thus, the supporting program 42 determines that the error event does not indicate an insufficient consumable error (C33: NO), and stops. That is, the supporting program 42 does not output any error notification.

In a case where the universal printing program 41 receives, from the printer 2, an error notification including a specific error code that indicates an error other than an insufficient consumable error, the universal printing program 41 does not receive a suppression notification from the supporting program 42. That is, the error notification suppression setting is not enabled. Therefore, the universal printing program 41 can display, on the display 13a, an error notification screen for notifying an error other than an insufficient consumable error.

The supporting program 42 that has passed the suppression notification to the universal printing program 41 accesses the printer 2 to obtain consumable information (C35). The consumable information may be related to a consumable compatible with the printer that has output the error notification. In one example, the supporting program 42 may obtain consumable information about each consumable compatible with the printer that has output the error notification. In another example, the supporting program 42 may obtain consumable information only about each of one or more consumables that are insufficient among all the consumables compatible with the printer that has output the error notification.

More specifically, in a case where the universal printing program 41 outputs an error event indicating an insufficient ink error, the supporting program 42 obtains consumable information about an ink cartridge from the printer 2. When the printer 2 is a color printer, the supporting program 42 obtains consumable information about each ink cartridge used in the printer 2 by color. In this case, each consumable information includes, for example, ink color information and ink remaining amount information. Further, the supporting program 42 obtains the printer model, from the printer 2. Step S34 is an example of “remaining amount obtaining processing”, “consumable information obtaining processing”, and “device information obtaining processing”. The consumable information may be obtained from the capabilities information, as in steps C06 to C09.

When an error occurs due to an insufficient consumable, the printer 2 may output an error notification including consumable information about a consumable (e.g., ink) that is insufficient. In this case, step C35 may be omitted. When the error event includes consumable information, the supporting program 42 may analyze the error event to obtain the consumable information. When the error event does not include consumable information, the supporting program 42 may obtain the consumable information from the universal printing program 41.

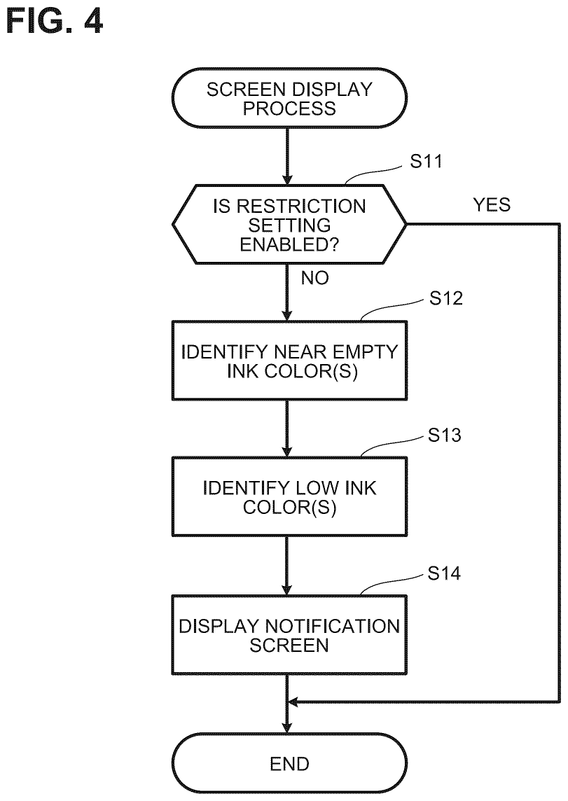

After obtaining the consumable information, the supporting program 42 executes a screen display process for displaying a notification screen based on the obtained consumable information (C36). The screen display process will be described with reference to FIG. 4.

The CPU 11 of the PC 1 determines whether the restriction setting is enabled (S11). The restriction setting specifies whether the display of the notification screen is restricted. If the flag in the restriction setting information 48 is ON, the CPU 11 determines that the display of the notification screen is restricted, that is, the restriction setting is enabled (S11: YES), and ends the screen display process. This is because the notification screen is not displayed due to a restriction set by the user, which means the user does not intend to see the notification screen.

If the flag in the restriction setting information 48 is OFF, the CPU 11 determines that the display of the notification screen is not restricted, that is, the restriction setting is not enabled (S11: NO), and identifies one or more near empty ink colors (S12). For example, the CPU 11 determines, for each ink color, whether the ink remaining amount included in the consumable information obtained in step C35 is near empty, by comparing the ink remaining amount with the threshold information 49 stored in the memory 12. Assuming that an ink remaining amount of 100% is considered full, the threshold information 49 includes an ink remaining amount of 23% as a first threshold. The supporting program 42 compares the ink remaining amount of each ink color with the first threshold (e.g., 23%), and identifies one or more ink colors whose ink remaining amount is less than the first threshold. More specifically, when the remaining amounts of cyan (C) and magenta (M) inks are below the first thresholds (e.g., 23%), the CPU 11 identifies cyan and magenta as near empty ink colors. Step S12 is an example of “first identifying processing”.

The CPU 11 further identifies one or more low ink colors (S13). That is, the CPU 11 identifies one or more ink colors whose ink remaining amount is equal to or slightly greater than the first threshold. In one example, the supporting program 42 identifies one or more ink colors with low ink levels. In another example, in a case where the threshold information 49 includes a second threshold (e.g., 30%), the supporting program 42 may identify, as low ink color, one or more ink colors whose remaining amounts is equal to or greater than the first threshold (e.g., 23%) used in step S12 and less than the second threshold (e.g., 30%). The second threshold may be an approximate threshold to the first threshold, and may be used as a reference when determining whether the ink remaining amount is low. For example, when the remaining amount of black (BK) ink is 25%, the CPU 11 identifies black as low ink color. Step S13 is an example of “second identifying processing”.

Subsequent to step S13, the CPU 11 displays a notification screen on the display 13a of the user IF 13 based on the consumable information (S14). The consumable information may include the consumable information related to the one or more ink cartridges corresponding to the one or more ink colors identified in step S12, and the consumable information related to the one or more ink cartridges corresponding to the one or more ink colors identified in step S13. Thereafter, the CPU 11 ends the screen display process. Step S14 is an example of “notification processing” and “recommendation processing”.

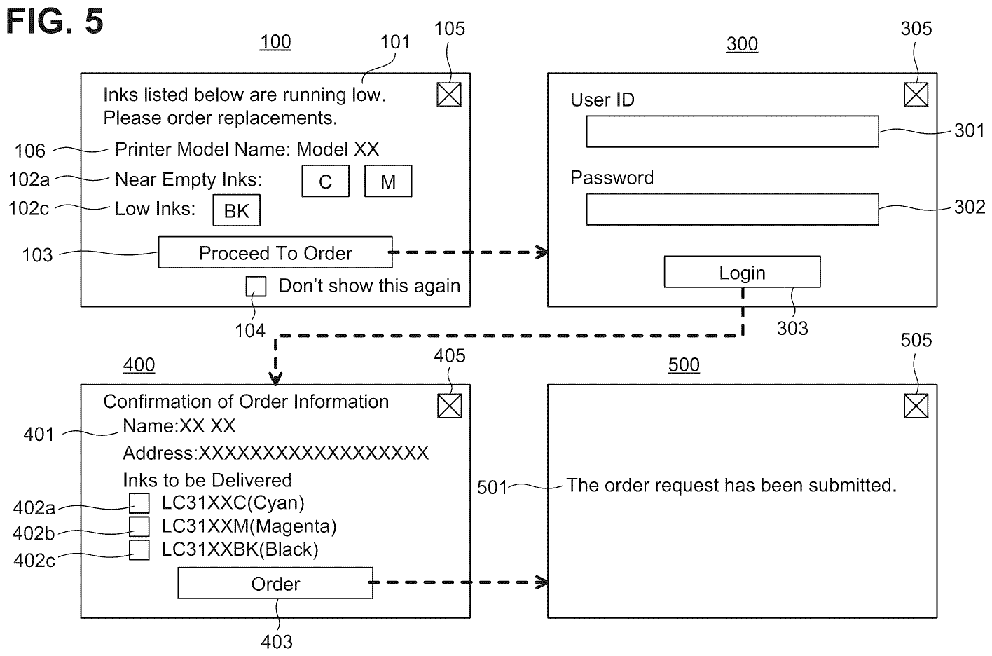

FIG. 5 illustrates an example of a notification screen 100. The notification screen 100 includes various display areas such as a message area 101, a printer model name area 106, a “Near Empty Inks” area 102a, and an “Low Inks” area 102c. The notification screen 100 further includes a button 103, a check box 104, and a close button 105. The button 103 is used to proceed to an ordering procedure. The check box 104 allows the user to enable or disable the restriction setting. The button 103 is an example of an “UI element”. The notification screen 100 is an example of a “recommendation screen”.

In the message area 101, a message that prompts the purchase one or more consumables is displayed. The message may be, for example, “Inks listed below are running low. Please order replacements.” Such a message may enable the user to recognize the need to purchase consumables such as ink, that is, the timing for purchasing consumables, even when the user is not physically near the printer 2.

In the printer model name area 106, the model name of the printer 2 that has output an error notification is displayed. For example, when the supporting program 42 obtains capabilities data including the model name of the printer 2 through steps C06 to C09, or when the model name of the printer 2 is registered in the supporting program 42, the supporting program 42 may display, in the printer model name area 106, the model name that is included in the capabilities data or registered in the supporting program 42, without performing step C35, in which the model name is obtained from the printer 2.

In the “Near Empty Inks” area 102a, for example, the colors “C” (cyan) and “M” (magenta) identified in step S12 are displayed. Such a display may enable the user to recognize the need to purchase the cyan and magenta inks.

In the “Low Inks” area 102c, the color “BK” (black) identified in step S13 is displayed. Such a display may also enable the user to recognize that the black ink will soon need to be replaced and that purchasing the black ink is recommended.

Another information, for example, consumable identification information for identifying a consumable may also be included in the “Near Empty Inks” area 102a and the “Low Inks” area 102c, respectively. The consumable identification information may be, for example, a model name of an ink cartridge. Including such information may improve user convenience when purchasing consumables.

After confirming the contents of the notification screen 100, the user may check the check box 104 via the user IF 13 to prevent the display of the notification screen 100 every time printing is performed. If the user orders ink at this time, the user operates the button 103 via the user IF 13. If the user does not order any ink at this time, the user operates the close button 105 via the user IF 13.

Referring back to FIG. 2B, in response to the button 103 included in the notification screen 100 being operated, the supporting program 42 displaying the notification screen 100 receives an instruction to start the ordering procedure (C41). The button 103 is linked to the URL for a consumables purchase site provided by the server 3. The supporting program 42 launches the browser 45 and causes the browser 45 to display a web page specified by the URL to which the button 103 is linked. That is, the browser 45 receives web page information 3a from the server 3 and opens the web page (C43). Step C43 is an example of “first purchase processing”, “second purchase processing”, “fourth purchase processing”, and “third obtaining processing”.

An example procedure for purchasing a consumable will be described with reference to FIG. 5. When the button 103 on the notification screen 100 displayed by the supporting program 42 is operated on the PC 1, a login screen 300 provided by the server 3 is displayed on the user IF 13 by the browser 45. The login screen 300 includes a user ID entry field 301, a password entry field 302, a login button 303, and a close button 305. In response to the user operating the login button 303 after entering their user ID and password into the user ID entry field 301 and the password entry field 302, respectively, the server 3 performs authorization based on the entered user ID and password. If authentication is successful, the server 3 provides a purchase screen 400 to the browser 45. Thus, the browser 45 displays the purchase screen 400 on the display 13a of the PC 1.

When the supporting program 42 passes the URL to the browser 45, the supporting program 42 also passes the model name of the printer 2 obtained from the printer 2, and information related to the insufficient consumable including, for example, the near empty ink color and the low ink color. More specifically, the server 3 extracts the consumable information related to each ink cartridge corresponding to the model name of the printer 2 and color passed from the browser 45, and provides the browser 45 with the purchase screen 400 that allows the user to request the purchase of ink cartridges corresponding to the extracted consumable information.

For example, in a case where the universal printing program 41 receives, from the printer 2, an error notification including consumable information related to an ink cartridge with a near empty ink level, the supporting program 42 may obtain the consumable information from the universal printing program 41 and pass the consumable information to the browser 45 together with the URL. In a case where the server 3 receives the consumable information from the browser 45, the server 3 may provide the browser 45 with the purchase screen 400 that includes the received consumable information. If the consumable information includes, for example, consumable identification information that identifies an ink cartridge, the purchase screen 400 may include the consumable identification information. The consumable identification information may be, for example, an ink model name.

For example, the purchase screen 400 of FIG. 5 includes an information area 401. In the information area 401, information that identifies the user is displayed. The purchase screen 400 includes ink model names that are compatible with the model of the printer 2 and correspond to the near empty ink colors “C” and “M”. The purchase screen 400 includes another ink model name that is compatible with the model of printer 2 and corresponds to the low ink color “BK”. The purchase screen 400 further includes check boxes 402a, 402b, and 402c, each of which is associated with a respective model name. The check boxes 402a, 402b, and 402c allow the user to select which replacement inks to purchase. The user checks one or more of the check boxes 402a, 402b, or 402c and operates an order button 403, thereby finalizing the order for the one or more replacement inks associated with the checked model names. Such a configuration may eliminate the need for the user to look up the ink model names compatible with the printer 2, thereby facilitating the purchase of replacement inks. In addition, since the user is allowed to select which replacement inks to purchase, the user can determine which ones to purchase based on the current stock.

In other embodiments, for example, the check boxes 402a and 402b associated with near empty inks may be displayed as checked, and the check box 402c associated with a low ink is allowed to be checked by the user as necessary. Such a configuration may thus reduce the likelihood that the user forgets to purchase a replacement consumable for a near empty ink color. In addition, the user is allowed to determine whether to purchase a replacement consumable for a low ink color. The purchase screen 400 further includes a close button 405. If the user does not order any ink at this time, the user may operate a close button 405 via the user IF 13.

In response to receiving the order according to the content specified on the purchase screen 400, the server 3 passes a request completion screen 500 to the browser 45. Thus, the browser 45 displays the request completion screen 500 on the display 13a of the PC 1. The request completion screen 500 includes a message area 501. In the massage area 501, a message indicating, for example, that the ink order request has been submitted is displayed. The user is allowed to close the request completion screen 500 by operating a close button 505 included in the request completion screen 500 using the user IF 13.

The purchase screen 400 may be displayed without passing through the login screen 300. The display of the purchase screen 400 may be implemented by the supporting program 42. If the supporting program 42 has a browser function, the supporting program 42 may directly access the server 3 to display the login screen 300 or the purchase screen 400.

In response to receiving an operation on the close button 105 of the notification screen 100 or on the close button 505 of the request completion screen 500, the supporting program 42 terminates the display of the notification screen 100 (C61). In the illustrative embodiment, the supporting program 42 controls the display of the notification screen. Nevertheless, in other embodiments, for example, the OS 21 may control the display of the notification screen in response to a request from the supporting program 42.

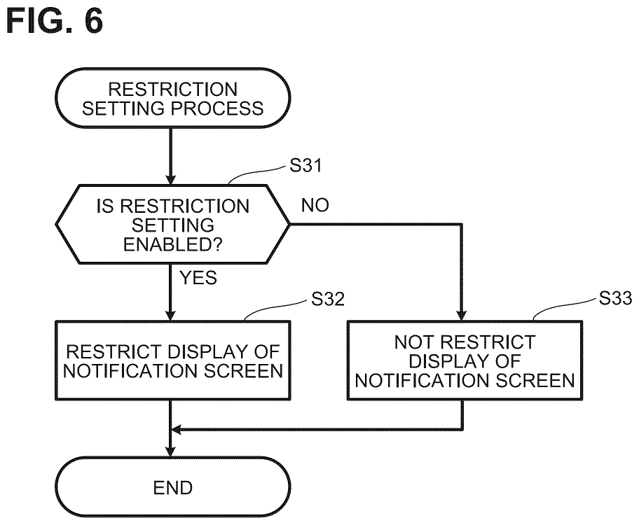

After terminating the display of the notification screen, the supporting program 42 executes a restriction setting process to update the restriction setting information 48 (C62). For example, as illustrated in the flowchart of FIG. 6, the CPU 11 determines whether the restriction setting is enabled (S31).

If the display of the notification screen 100 is terminated with the check box 104 on the notification screen 100 being unchecked, the CPU 11 determines that the restriction setting is not enabled (S31: NO). In this case, the CPU 11 sets the flag in the restriction setting information 48 to OFF, thereby not restricting the display of the notification screen (S33), and then ends the restriction setting process. Thus, if the one or more insufficient inks have not been replaced before the next printing is performed, the supporting program 42 executes the screen display process of step C36 to display the notification screen 100 at the next printing in the same manner as described above.

If the display of the notification screen 100 is terminated with the check box 104 on the notification screen 100 being checked, the CPU 11 determines that the restriction setting is enabled (S31: YES). In this case, the CPU 11 sets the flag in the restriction setting information 48 to ON, thereby restricting the display of the notification screen (S32), and then ends the restriction setting process. Thus, even when the universal printing program 41 outputs an error event in response to receiving an error notification indicating an insufficient ink from the printer 2 at the next printing, the supporting program 42 does not display the notification screen 100 on the user IF 13. Once the restriction setting is enabled, the supporting program 42 does not display the notification screen 100 on the user IF 13 until the restriction setting is disabled, that is, until the flag is turned OFF, in the update process (C10). The processing in which the CPU 11 receives specification of the restriction setting via the check box 104 is an example of “restriction setting processing”.

As described above in detail, when an error event indicating an insufficient consumable error is output from the universal printing program 41 in response to a print instruction, the supporting program 42 causes the PC 1 to display the notification screen 100 that prompts the purchase of a replacement consumable. Such a configuration may enable the user to recognize the need to purchase a replacement consumable, thereby increasing the likelihood that the user will purchase the replacement consumable.

While the disclosure has been described in detail with reference to the specific embodiment thereof, this is merely an example, and various changes, arrangements and modifications may be applied therein without departing from the spirit and scope of the disclosure. Any apparatuses or devices having a printing function may be connected to the PC 1. Examples of such apparatuses or devices include multifunction peripherals, copying machines, and facsimile machines. A plurality of printers, for example, two or more printers may be connected to the PC 1.

In the illustrative embodiment, the notification screen for an insufficient consumable is displayed, taking insufficient ink as an example of the insufficient consumable. Nevertheless, in other embodiments, a notification screen may be displayed when a consumable other than ink, such as sheets, becomes insufficient.

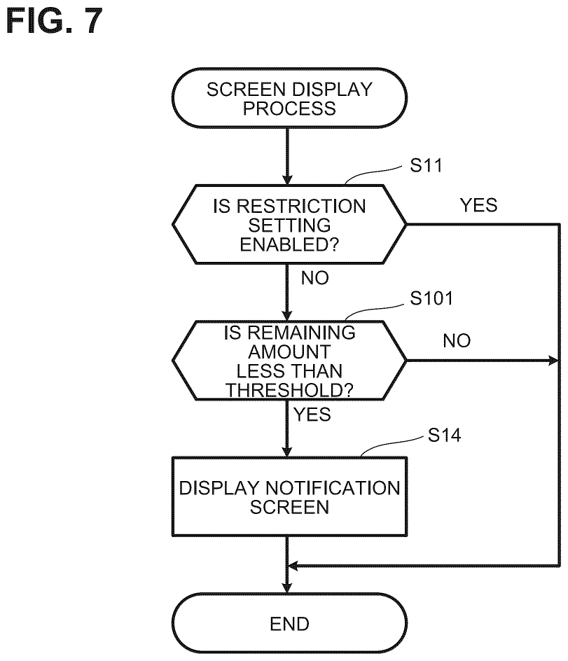

For example, the screen display procedure illustrated in FIG. 4 may be replaced with a screen display procedure illustrated in a flowchart of FIG. 7. According to the screen display procedure, even when the supporting program 42 receives an error event indicating an insufficient consumable from the universal printing program 41, the supporting program 42 obtains the remaining amount of the consumable from the printer. As illustrated in FIG. 7, if the CPU 11 determines that the obtained remaining amount is less than a threshold (S101: YES), the supporting program 42 displays the notification screen 100 (S14). If the CPU 11 determines that the remaining amount is not less than the threshold (S101: NO), the supporting program 42 does not display the notification screen 100. For example, if the user does not intend to replace the consumable even when the consumable reaches a low level, such a configuration ensures that, even if the universal printing program 41 outputs an error event indicating an insufficient consumable at the low level, the supporting program 42 does not display the notification screen unless the remaining amount falls below the threshold. This may enable the user to be notified at a more appropriate timing for purchase the consumable.

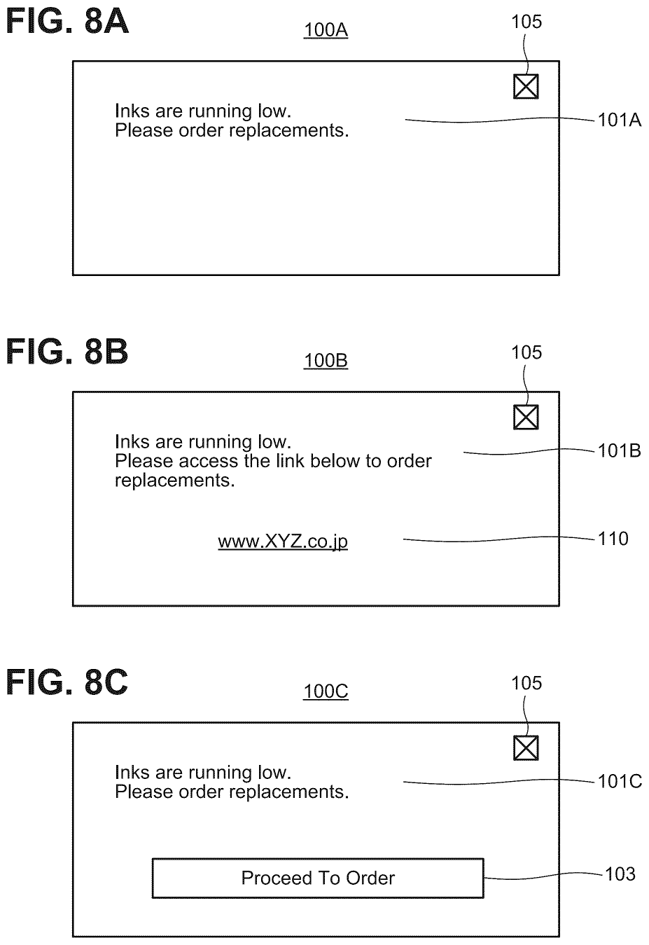

The screens to be displayed on the user IF 13 illustrated in the illustrative embodiment are all examples. In one example, instead of the notification screen 100 of FIG. 5, a notification screen 100A of FIG. 8A may be displayed. The notification screen 100A may include only a message area 101A. In the message area 101A, a message that prompts the purchase of a replacement consumable may be displayed.

In another example, instead of the notification screen 100 of FIG. 5, a notification screen 100B of FIG. 8B may be displayed. The notification screen 100B may include a message area 101B and a link 110. In the massage area 101B, a message that prompts the user to access the link 110 and purchase a replacement consumable may be displayed. The link 110 may provide access to a web page for purchasing the replacement consumable. When the user operates the link 110, the supporting program 42 executes processing in the same manner as when the user operates the button 103 of the notification screen 100 in FIG. 5. Including the link 110 to the web page for purchasing the replacement consumable in the notification screen 100B may enable the user to readily access the web page, thereby facilitating the purchase of the replacement consumable.

In still another example, instead of the notification screen 100 of FIG. 5, a notification screen 100C of FIG. 8C may be displayed. The notification screen 100C may include only a message area 101C and the button 103. Including the button 103 for purchasing a replacement consumable in the notification screen 100C may enable the user to readily access the purchase screen 400 by operating the button 103, thereby facilitating the purchase of the replacement consumable.

When the supporting program 42 receives an error event indicating an insufficient ink error from the universal printing program 41, the supporting program 42 may display a notification screen without obtaining the ink remaining amount from the printer 2 in step C35.

When the printer 2 is a monochrome printer, steps S12 and S13 of FIG. 4 may be omitted so as not to include the “Near Empty Inks” area 102a and the “Low Inks” area 102c in the notification screen 100.

Even when the printer 2 is a color printer, steps S12 and S13 of FIG. 4 may be omitted so as not to include the “Near Empty Inks” area 102a and the “Low Inks” area 102c in the notification screen 100. Nevertheless, when the printer 2 is a color printer, it is preferable that the remaining amount of each color ink is obtained from the printer 2, and one or more near empty ink colors are identified and displayed in the “Near Empty Inks” area 102a on the notification screen 100. This may enable the user to recognize which color consumable needs to be purchased. If one ink color is identified as near empty consumable and another the ink color is identified as low consumable, purchasing replacement consumables for both at the same time may be efficient in terms of delivery. Therefore, the notification screen 100 preferably includes the “Low Inks” area 102c to recommend that the user purchase a replacement consumable for the consumable with a low ink level.

The purchase screen 400 of FIG. 5 may include an ink list to allow the user to select one or more inks to be purchased. The ink list may include, for example, all colors of ink compatible with the model of the printer 2 or all types of ink currently sold. In this case, including, on the purchase screen 400, the ink model names of the near empty ink colors and the check boxes 402a, 402b, and 402c associated with the ink model names may facilitate the purchase of replacement consumables for the consumables with near empty levels.

The supporting program 42 might not need to obtain the model name of the printer 2. In other words, the notification screen 100 might not need to include the printer model name area 106 or the purchase screen 400 might not include consumables compatible with the model of the printer 2. Nevertheless, it is preferable that the supporting program 42 notifies the user of the model of the printer 2 via the notification screen 100 and displays the purchase screen 400 for the consumables compatible with the model. This may facilitate the user to purchase the consumables compatible with the printer 2 to be used for printing. In this case, the purchase screen 400 may include all colors of ink compatible with the model of the printer 2. Nevertheless, it is preferable that only a near empty ink is displayed on the purchase screen 400. This may enable the user to purchase a replacement consumable for the consumable with a near empty ink level at an appropriate time.

In other embodiments, for example, step C35 may be omitted. In other word, the supporting program 42 might not necessarily obtain consumable information from the printer 2. In this case, the notification screen 100 might not include consumable information. The purchase screen 400 may include consumable information to allow the user to request the purchase of replacement consumables. The consumable information includes information about both insufficient and sufficient consumables. Nevertheless, it is preferable that the supporting program 42 displays, on the user IF 13, a notification screen 100 including consumables compatible with the printer 2, based on the obtained consumable information, and displays a purchase screen 400 for replacement consumables associated with the consumable information. This may facilitate the user's purchase of replacement consumables for insufficient consumables. Such a configuration may also facilitate the user's purchase of the same consumables as those currently used in the printer 2.

The check box 104 of the notification screen 100 in FIG. 5 may be omitted. In other words, the supporting program 42 may skip the restriction setting process in FIG. 6. Nevertheless, in this case, the notification screen 100 is displayed each time printing is performed if one or more consumables are insufficient. However, such a display manner may cause inconvenience to the user. Therefore, for example, it is preferable that the check box 104 is included in the notification screen 100 to allow the user to enable the restriction setting to restrict the display of the notification screen 100. This may reduce inconvenience to the user.

In other embodiments, for example, steps C06 to C10 of FIG. 2A may be omitted. In other words, the supporting program 42 might not disable the restriction on the display of the notification screen. However, if the supporting program 42 obtains consumable information from the printer 2 while the display of the notification screen is restricted and determines, based on the consumable information, that an insufficient consumable error has not occurred, it is highly likely that the consumable has been replaced and, therefore, the insufficient consumable error has been resolved. Therefore, by disabling the restriction setting for the display of the notification screen, the supporting program 42 is allowed to display the notification screen again when an insufficient consumable error occurs, thereby allowing the user to be notified of the appropriate timing for purchasing replacement consumables.

Step C34 in FIG. 2B may be omitted. In other words, both the supporting program 42 and the universal printing program 41 may notify the user of an insufficient consumable error. Nevertheless, it is preferable that if it is normal for the universal printing program 41 to notify errors, the supporting program 42 passes a suppression notification to the universal printing program 41 and enables the error notification suppression setting in the universal printing program 41. This may thus avoid duplicate error notifications regarding an insufficient consumable error from both the universal printing program 41 and the supporting program 42.

In the illustrative embodiment, the notification screen 100 includes the “Low Inks” area 102c. In other words, a single screen includes a notification screen, which notifies of a near empty ink, and a recommendation screen, which recommends the purchase of a replacement consumable for the consumable with a low ink level. Alternatively, the recommendation screen and the notification screen may be provided as separate screens.

In the illustrative embodiment, the description has been provided on only the printing operation in which the supporting program 42 is involved. However, the supporting program 42 may be involved in another operation in addition to the printing operation. Any program may be applicable instead of the supporting program 42, as long as the program receives an instruction from the OS 21 or the universal printing program 41 when printing is performed using the universal printing program 41. For example, the alternative program may be a print workflow application (Print Workflow) whose specification has been disclosed by Microsoft Corporation.

In any flowchart disclosed in the illustrative embodiment, steps may be executed in a different order or in parallel, as long as no contradiction occurs in the contents of the procedures.

The processing in all steps disclosed in the illustrative embodiment may be executed by hardware, such as a single CPU, multiple CPUs, an ASIC, or a combination thereof. The processing in all steps disclosed in the embodiment may be implemented in various aspects such as a recording medium storing a computer-readable program for executing the processing, or a method.

What is claimed is:

1. A non-transitory computer-readable storage medium for an information processing device, the information processing device including a controller, the non-transitory computer-readable storage medium storing computer-executable instructions for implementing a supporting program for a printer connectable to the information processing device, wherein the information processing device has an operating system including a universal printing program, the information processing device is incorporated with an application program, the supporting program that, when executed by the controller, causes the information processing device to perform:
in response to the universal printing program receiving, from the application program, a print instruction that causes the printer to print an image to be printed,
printing processing of causing the printer to print the image to be printed;
receiving processing of receiving an error event from the universal printing program, the error event being output by the universal printing program in response to the universal printing program receiving an error notification from the printer after the printing; and
in a case where the error event output from the universal printing program indicates an insufficient consumable error, notification processing of displaying a notification screen that prompts purchase of a replacement consumable on a user interface of the information processing device.

2. The non-transitory computer readable storage medium according to claim 1, wherein the notification screen includes a link to a web page for purchasing the replacement consumable.

3. The non-transitory computer readable storage medium according to claim 1,
wherein the notification screen includes an UI element,
wherein the supporting program, when executed by the controller, causes the information processing device to perform:
in response to the UI element being operated, first purchase processing of displaying a purchase screen for receiving a request to purchase the replacement consumable.

4. The non-transitory computer readable storage medium according to claim 1,
wherein the supporting program, when executed by the controller, causes the information processing device to perform:
in a case where the error event output from the universal printing program indicates the insufficient consumable error, remaining amount obtaining processing of obtaining a consumable remaining amount used in the printer;
comparing the obtained consumable remaining amount with a threshold;
based on the comparison result that the consumable remaining amount is lower than the threshold, performing the notification processing; and
based on the comparison result that the consumable remaining amount is greater than or equal to the threshold, not performing the notification processing.

5. The non-transitory computer readable storage medium according to claim 1,
wherein the printer is a color printer,
wherein the supporting program, when executed by the controller, causes the information processing device to perform:
in a case where the error event output from the universal printing program indicates the insufficient consumable error, remaining amount obtaining processing of obtaining a consumable remaining amount for each color used in the printer; and
first identifying processing of identifying a consumable color with a near empty level based on the consumable remaining amount obtained for each color;
wherein in the notification processing, the notification screen that prompts purchase of a replacement consumable is displayed, the notification screen indicating the consumable color with the near empty level.

6. The non-transitory computer readable storage medium according to claim 5,
wherein the supporting program, when executed by the controller, causes the information processing device to perform:
second purchase processing of displaying a purchase screen on the user interface, the purchase screen being for receiving a request to purchase a replacement consumable for the consumable color with the near empty level.

7. The non-transitory computer readable storage medium according to claim 5,
wherein the supporting program, when executed by the controller, causes the information processing device to perform:
second identifying processing of identifying a consumable color with a low level based on the consumable remaining amount obtained for each color; and
in a case where a consumable color with a low level is identified, recommendation processing of displaying a recommendation screen that recommends the purchase of a replacement consumable for the consumable with the low ink level.

8. The non-transitory computer readable storage medium according to claim 1,
wherein the supporting program, when executed by the controller, causes the information processing device to perform:
in a case where the error event output from the universal printing program indicates the insufficient consumable error, device information obtaining processing of obtaining device information identifying a model of the printer,
wherein in the notification processing, the notification screen that prompts purchase of a replacement consumable is displayed, the notification screen indicating the model of the printer, and
wherein the supporting program, when executed by the controller, causes the information processing device to perform:
third purchase processing of displaying a purchase screen for receiving a request to purchase of a replacement consumable compatible with the model of the printer.

9. The non-transitory computer readable storage medium according to claim 1,
wherein the supporting program, when executed by the controller, causes the information processing device to perform:
in a case where the error event output from the universal printing program indicates the insufficient consumable error, consumable information obtaining processing of obtaining consumable information associated with a consumable compatible with the printer,
wherein in the notification processing, the notification screen that prompts purchase of a replacement consumable is displayed, the notification screen indicating the consumable associated with the obtained consumable information, and
wherein the supporting program, when executed by the controller, causes the information processing device to perform:
fourth purchase processing of displaying a purchase screen for receiving a request to purchase of a replacement consumable for the consumable associated with the obtained consumable information.

10. The non-transitory computer readable storage medium according to claim 1,
wherein the supporting program, when executed by the controller, causes the information processing device to perform:
in response to the notification screen being displayed, restriction setting processing of receiving an instruction to enable or disable a restriction setting for restricting display of the notification screen; and
in a case where the restriction setting is enabled, not performing the notification processing even when the error event is received from the universal printing program.

11. The non-transitory computer readable storage medium according to claim 10,
wherein the supporting program, when executed by the controller, causes the information processing device to perform:
in response to the print instruction, pre-obtaining processing of obtaining a consumable remaining amount from the printer prior to execution of the printing processing;
pre-determining processing of determining, based on the obtained consumable remaining amount, whether a consumable is at a near empty level; and
based on the determination that the consumable is not at the near empty level, disabling processing of disabling the restriction setting.

12. The non-transitory computer readable storage medium according to claim 1,
wherein the supporting program, when executed by the controller, causes the information processing device to perform:
in a case where the error event output from the universal printing program indicates the insufficient consumable error, setting processing of enabling or disabling a suppression setting with respect to the universal printing program,
in a case where the suppression setting is enabled, the universal printing program notifies an error when receiving the error notification from the printer; and
in a case where the suppression setting is disabled, the universal printing program does not notify the error even when receiving the error notification from the printer.

13. A non-transitory computer-readable storage medium for an information processing device, the information processing device including a controller, the non-transitory computer-readable storage medium storing computer-executable instructions for implementing a supporting program, wherein the information processing device has an operating system including a universal printing program, the supporting program that, when executed by the controller, causes the information processing device to perform:
in response to receiving an image to be printed from the universal printing program, causing a printer to print the image to be printed;
receiving, from the universal printing program, an error event which indicates an insufficient consumable error, after the printing; and
in response to receiving the error event, displaying a notification screen that prompts purchase of a replacement consumable on a user interface of the information processing device.

14. The non-transitory computer readable storage medium according to claim 13, wherein the notification screen includes a link to a web page for purchasing the replacement consumable.

15. The non-transitory computer readable storage medium according to claim 13,
wherein the notification screen includes an UI element,
wherein the supporting program, when executed by the controller, causes the information processing device to perform:
in response to the UI element being operated, displaying a purchase screen for receiving a request to purchase the replacement consumable.

16. The non-transitory computer readable storage medium according to claim 13,
wherein the supporting program, when executed by the controller, causes the information processing device to perform:
in a case where the error event output from the universal printing program indicates the insufficient consumable error, obtaining a consumable remaining amount used in the printer;
comparing the obtained consumable remaining amount with a threshold;
based on the comparison result that the consumable remaining amount is lower than the threshold, displaying the notification screen; and
based on the comparison result that the consumable remaining amount is greater than or equal to the threshold, not displaying the notification screen.

17. The non-transitory computer readable storage medium according to claim 13,
wherein the printer is a color printer,
wherein the supporting program, when executed by the controller, causes the information processing device to perform:
in a case where the error event output from the universal printing program indicates the insufficient consumable error, obtaining a consumable remaining amount for each color used in the printer; and
identifying a consumable color with a near empty level based on the consumable remaining amount obtained for each color;
wherein the displaying the notification screen including displaying the notification screen that prompts purchase of a replacement consumable, the notification screen indicating the consumable color with the near empty level.

18. The non-transitory computer readable storage medium according to claim 17,
wherein the supporting program, when executed by the controller, causes the information processing device to perform:
displaying a purchase screen on the user interface, the purchase screen being for receiving a request to purchase a replacement consumable for the consumable color with the near empty level.

19. The non-transitory computer readable storage medium according to claim 13,
wherein the supporting program, when executed by the controller, causes the information processing device to perform:
in response to the notification screen being displayed, receiving an instruction to enable or disable a restriction setting for restricting display of the notification screen; and
in a case where the restriction setting is enabled, not displaying the notification screen even when the error event is received from the universal printing program.

20. The non-transitory computer readable storage medium according to claim 19,
wherein the supporting program, when executed by the controller, causes the information processing device to perform:
obtaining a consumable remaining amount from the printer prior to execution of the printing;
determining, based on the obtained consumable remaining amount, whether a consumable is at a near empty level; and
based on the determination that the consumable is not at the near empty level, disabling the restriction setting.
